(19) United States
(12) Patent Application Publication
(10) Pub. No.: US 2003/0031992 A1
(43) Pub. Date: Feb. 13, 2003

(54) Platform independent telecollaboration medical environments

(76) Inventors: Robert J. Laferriere, Wauwatosa, WI (US); Francis W. Kasper, Milwaukee, WI (US)

Correspondence Address: FLETCHER, YODER & VAN SOMEREN, P. O. BOX 692289, HOUSTON, TX, 77269-2289, US

(21) Appl. No.: 09/682,238

(22) Filed: Aug. 8, 2001

(51) Int. Cl. G09B 23/28

(52) U.S. Cl. 434/262

(57) ABSTRACT

A technique is provided for collaboratively training, servicing, managing and interacting with a remote computing system and persons associated with a medical diagnostic imaging system. Screen data is captured, transmitted and cached between a plurality of remote computing systems and persons to facilitate shared computing for medical environments.

### BACKGROUND OF INVENTION

The present invention relates generally to the field of collaborative computing systems and environments. More particularly, the invention relates to techniques for training, servicing, managing and interacting with software, medical equipment and persons by sharing screen views in a collaborative environment between remote computing systems and persons.

Medical systems, such as medical diagnostic imaging systems, often require configuration/setup, maintenance, servicing and other administrative operations to ensure proper operation by the user. Moreover, the user may require training, troubleshooting and various other services to ensure proper operation of the medical systems. These services are typically performed by telephone or email conversations between the user and technical personnel for the particular medical system. These techniques are costly and error prone. The technical personnel also may provide these services by actual meetings, training courses, service calls, and so forth. Actual meetings also are costly and they may result in significant down times due to slow response times and unavailability of the technical personnel. Accordingly, an improved communication technique is needed to facilitate setup, training, servicing and other administrative functions for medical systems.

A range of computer applications and techniques are known and used for receiving and displaying screens, typically employed as graphical user interfaces. In conventional web browsers, for example, screens are defined by code which is tagged to represent such features as placement, color, text, fonts, and so forth. Additional tags may refer to links for graphical items, such as pictures and icons. When a user accesses a page, an application, which is typically running at the user's computer, sends commands which are interpreted by a communicating computer to transmit the code which defines the screens. Where applications are running locally on the user”s computer, such as word processing applications, spreadsheet applications, and any other applications employing a user interface, the application code itself generally defines the user interface screens, including the text or images displayed, interface tools, such as buttons and menus, and so forth.

Applications running on a user”s computer or workstation are generally adapted to track input events, such as mouse clicks and keyboard inputs, to process or manipulate the application data and commands in accordance with the user”s desires. Thus, where a graphical user interface screen includes a virtual button at a defined location, a click on the virtual button creates a command which can be interpreted by the application in accordance with the code defining the screen, in this particular example, the button on which the user clicked. Wide range of such graphical user interfaces have been developed and are currently in use for controlling an application at a local workstation or for controlling an interface and an application where the interface and the application are at different locations. However, there are no shared or collaborative computing environments to facilitate setup, training, servicing and other functions for software, equipment and persons associated with medical systems.

There is a need, therefore, for an improved technique for training, servicing, managing and interacting with software, equipment and persons in a medical environment. In particular, a collaborative computing environment (e.g., a shared graphical interface) is needed to facilitate efficient and accurate configuration, training, maintenance, servicing, troubleshooting, administration and other functions for medical systems.

### SUMMARY OF INVENTION

The present invention provides a technique for collaboratively training, servicing, managing and interacting with a remote computing system and persons associated with a medical system, such as a medical diagnostic imaging system. Screen data is captured, transmitted and cached between a plurality of remote computing systems and persons to facilitate shared computing for medical environments. The technique may be employed in a wide range of medical environments, but is particularly well suited for remotely viewing and interacting with remote computing systems for training and trouble shooting situations. Moreover, the technique may be used with any suitable software, hardware and equipment in any number of remote locations. For example, an application may be resident on and executed from one or more remote locations, and any number of computing systems may share a computing environment (e.g., a graphical interface) to facilitate user interaction, training, servicing and other functions.

An aspect of the present technique provides a method for remotely servicing a medical diagnostic imaging system. The method includes providing a shared computing environment for a remote computing system coupled to a medical diagnostic imaging system. The method also includes collaboratively interacting with the remote computing system via the shared computing environment to service the medical diagnostic imaging system.

Another aspect of the present technique provides a method for remotely training persons having a medical diagnostic imaging system. The method includes providing a collaborative computing environment between a trainee and a remote trainer for a medical diagnostic imaging system. The method also includes interactively instructing the trainee via the collaborative computing environment.

Another aspect of the present technique provides a method for collaborating between remote computing environments, including a medical diagnostic imaging system. The method includes initiating a link between remote computing environments and sharing a graphical user interface with the remote computing environments. The method also includes collaboratively interacting with a medical diagnostic imaging system coupled to one of the remote computing environments.

Another aspect of the present technique provides a system for collaboratively interacting between remote computing environments associated with a medical diagnostic imaging system. The system has a first computing system coupled to a medical diagnostic imaging system and a second computing system remotely coupled to the first computing system via a network. The system also has a graphical user interface being shared by the first and second computing systems for collaboratively interacting with the medical diagnostic imaging system.

### BRIEF DESCRIPTION OF DRAWINGS

FIG. 1 is a diagrammatical representation of two computer workstations coupled in a collaborative environment and employing aspects of the present technique;

FIG. 2 is a simplified diagrammatical representation of the system illustrated in FIG. 1, wherein an iconification command is input at the controlling computer;

FIG. 3 is a diagrammatical representation similar to that of FIG. 2, wherein a window move command is input by the controlling computer;

FIG. 4 is a flow chart illustrating exemplary control logic in executing the caching and data transmission operations of the present technique;

FIG. 5 is a diagrammatical representation of a collaborative environment similar to that illustrated in the previous figures, but in which two controlling computers are coupled to a controlled computer over a network; and

FIG. 6 is a diagrammatical representation of an exemplary implementation of the present technique in a medical diagnostic application wherein a controlled computer is coupled directly to a medical diagnostic imaging system and the technique is employed for training, servicing or other administrative purposes.

### DETAILED DESCRIPTION

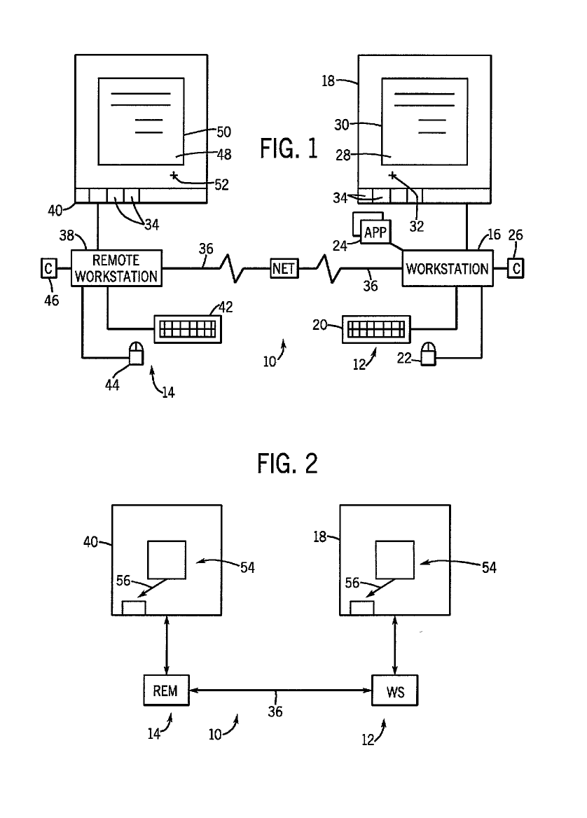

The present technique provides a system and method for configuring, maintaining, servicing and troubleshooting remote medical systems and applications. The present technique is also particularly well suited for training and interacting with remote persons using the remote medical systems and applications. Accordingly, a collaborative computing environment using screen sharing techniques is described below with reference to FIGS. 1-6. The screen sharing techniques facilitate simultaneous viewing of relevant information and mutual control and interaction with the underlying application or equipment linked to the shared interface (e.g., a shared graphical user interface). A screen caching assembly is also provided to speed up data transfer for the shared interface and to facilitate real time interaction between remote computing systems.

Referring now to FIG. 1, a system 10 is illustrated for providing display screens used in controlling one computer system via another computer system. In the illustrated system, a controlled computer system 12 is linked to a controlling computer system 14. The controlled and controlling computer systems 12 and 14 may include any suitable computers employing various hardware, firmware and software platforms. In a presently contemplated embodiment, for example, the computer systems include workstations that operate on a UNIX platform. However, any other suitable platform may be employed, including Solaris, IRIX, LINUX and so forth. In fact, the present technique facilitates collaborative computing between a plurality of computing systems at a plurality of remote locations, where each of the computing systems may have a distinctly different operating system or platform.

It should also be noted that, while the computer systems 12 and 14 are described as controlled and controlling, the present technique facilitates a shared or collaborative computing environment in which any number of applications, computer systems, and users can mutually view, control and generally interact with other remote users, applications and systems. Thus, the present technique links the remote computing systems and users through a shared interface (e.g., a shared graphical interface), which allows the systems and users to interact collaboratively and simultaneously. Accordingly, a remote technical personnel can interact with a remote system or person for efficiently and accurately configuring, troubleshooting or otherwise servicing the remote system. The remote technical personnel can view the information displayed on the persons computing system, guide the person through the proper steps, and quickly resolve any technical problem that may arise. The remote technical personnel also may interactively train the person by guiding the person through a software application, which may be the focus of the training or simply a means of training the person to configure, troubleshoot, service or operate the remote system (e.g., a medical diagnostic imaging system). As noted above, the present technique allows both the technical personnel and the person to mutually control and interact with the application or system via the shared interface. Moreover, the shared computing environment may include ten, twenty or any number or remote persons, who can interact via the shared interface to control, service, troubleshoot or learn by mutual interaction. Accordingly, the shared computing techniques described herein should be interpreted broadly, while it should be recognized that these techniques are particularly well suited for collaborative interaction among users and systems associated with medical systems.

As illustrated in FIG. 1, the controlled computer system 12 includes a workstation 16, one or more monitors 18 and various input devices, such as a conventional keyboard 20 and a mouse 22. An operating system and software applications running on the controlled computer system 12, such as via one or more CPUs of workstation 16, are thus interfaced via the input devices and the monitor. Such applications, designated generally by reference numeral 24 in FIG. 1, may include any suitable application, such as machine or system control applications, data processing applications, spreadsheets, data exchange applications, image viewing applications, browsers, and so forth. The applications will produce one or more display screens viewable on monitor 18 and which are conveyed to the controlling computer system 14 as described below. It should be noted that the applications 24 which are run by the controlled computer system 12 may, in practice, be a resident on and accessed from memory directly at the workstation, or may be provided at locations remote to the workstation, such as on local or wide area networks. Similarly, the processing performed to generate the user interface screens and to manipulate such screens based upon user inputs may be performed within workstation 16 or within various other processing circuitry linked to the workstation. In general, however, where reference is made herein to applications running on or by the controlled computer system 12, any suitable combination of storage and processing may be implemented whereby an operator at the controlled computer system 12 would normally manipulate the program via the input devices 20 and 22 and by reference to the user interface screens displayed on monitor 18.

In addition to any desired read-only memory, random access memory, optical memory, or any other suitable memory on workstation 16, system 12 includes cache memory 26 for storing data descriptive of screens displayed on monitor 18. Such screen displays 28 may generally include any type of user interface indicia, typically text, images, icons, and so forth. In a typical graphical user interface display, for example, one or more windows 30 will be viewable to frame portions of the screen which are logically associated with one another, such as windows generated by specific applications or functions of applications. Monitor 28 will also display a user input cursor 32 which may take any conventional form, and which may be moved about the screen display via one of the input devices 20 or 22. It should be noted that the input devices may include other types of tools, such as digitizers, probes, touch-sensitive screens or displays, and so forth. In the embodiment illustrated in FIG. 1, the screen also includes iconified displays 34, which may be aligned along a border of the display screen to indicate to the user that one or more applications is still active.

Controlled computer 12 is linked to controlling computer 14 via a network connection 36. While any suitable network connection may be employed, presently contemplated connections include local area networks, wide area networks, the Internet, virtual private networks, and so forth. Moreover, any suitable medium or media may be employed for the network connection, including cable, dedicated connections, wireless connections, or any combination of these or other media. The controlling computer system 14 includes a workstation 38, a monitor 40, and input devices 42 and 44. As noted above, any suitable computer system may be employed as the controlling computer system 14, and the latter need not be identical or even similar to the controlled computer system 12. Moreover, the controlled computer system 12 and the controlling computer system 14 may have different operating systems (e.g., Windows, Macintosh, UNIX, etc.), computing architectures, components, applications, and other distinctly different features, which the present technique uniquely ties together for collaborative computing in a shared graphical interface (e.g., shared screen images and functionality).

The controlling computer system 14 includes various memory, but preferably includes cache memory 46 for storing portions of the display screen as described below. The present technique permits screens to be displayed on monitor 40 which are substantially the same (e.g., substantially copied or simulated) as screens displayed on monitor 18 such that the controlling computer system 14 can originate inputs and track changes in the display on monitor 18 of the controlled computer system 12 so as to regulate operation of the controlled computer system 12 via the applications run by the controlled computer system 12. Thus, the screen display 48 provided on monitor 40 will be derived from that viewable on monitor 18, and will typically include the same windows 50, in the same locations, and with the same indicia displayed in the windows. A cursor 52 is displayed on monitor 40 of the controlling workstation, but is controllable completely independent of the cursor 32 on the controlled computer system 12.

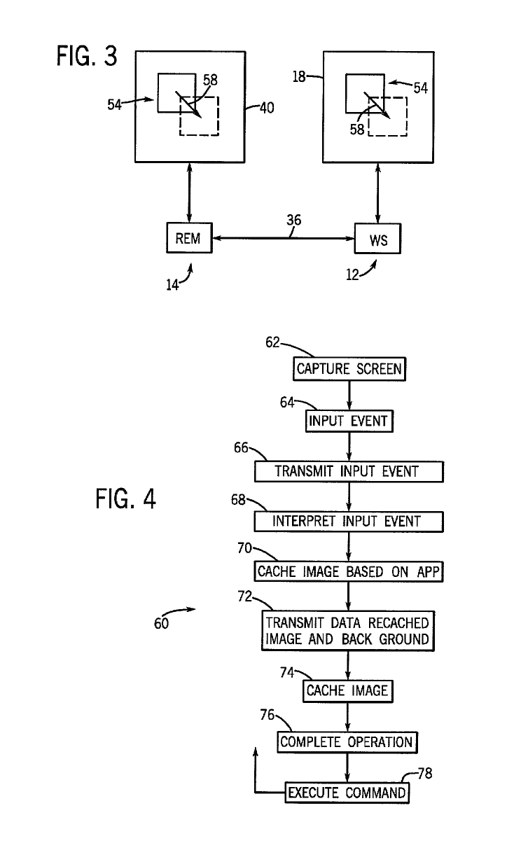

FIGS. 2 and 3 illustrate exemplary operations which serve as the basis for the present discussion of control implemented between the computer systems. As noted above, applications are run by the controlled computer system 12, but can be manipulated via the controlling computer system 14. In the example illustrated diagrammatically in FIG. 2, a display 54 is provided on both computer systems, with the display being originally generated by the applications run by the controlled computer system 12. In this example, the application window of the display is iconified or reduced to an icon as illustrated by arrows 56. In the second exemplary operation shown in FIG. 3, the display 54 is displaced from one location on the screen to another as indicated by arrows 58. In general, the nature of the operation is to provide the same display screen on the controlling computer system 14 as that generated by the applications run by the controlled computer system 12. Inputs made by the operator on the controlling computer system 14, then, are transmitted to the controlled computer system 12 where they are interpreted and implemented in accordance with the application. Where the input results in a change in the screen displayed on the controlled computer system 12, information regarding the change, including data for display on both systems, is transmitted back to the controlling computer system 14 to appropriately change its display. Portions of the display screen, which are logically grouped in accordance with the applications run by the controlled computer system 12, are then progressively cached to facilitate changes in the screens and to significantly reduce the volumes of data that are transmitted between the systems during the course of collaborative work.

FIG. 4 represents exemplary control logic for carrying out the screen display and caching operations in accordance with aspects of the present technique. The control logic, designated generally by reference numeral 60, begins with a screen capture as indicated at step 62. As noted above, the screen displayed on the controlled computer system 12 will typically be generated by one or more applications run by that computer system. At step 62, then, the screen is simply captured at the controlled computer system 12 and data defining the screen is transmitted to the controlling computer system 14 via the network 36. At this point, both computer systems display similar screens, and the operator at the controlling computer system 14 may manipulate the location of a cursor 52 (See, FIG. 1) or may enter any desired input based upon this cursor position or any other allowed parameter of the input devices.

Upon occurrence of an input event, such as a mouse click at a desired cursor position, or depressing one or more keys on a keyboard, an input event is logged as indicated at step 64 in FIG. 4. As will be appreciated by those skilled in the art, such input events are encoded in accordance with the particular input devices employed. Signals resulting from encoding of the input event at step 64 are transmitted at step 66 from the controlling computer system 14 to the controlled computer system 12 via the network 36. At step 68, the input event is interpreted at the controlled computer system 12. In general, such interpretation will be based not only on the nature and type of input event, but upon the location of cursor 52 on the controlling computer system 14 at the time of the input event, or similar data, and upon the meaning of that event in the applications running on the controlled computer system 12. In other words, the input event originating in the controlling computer system 14 is interpreted by the controlled computer system 12 as if the input event had occurred at the controlled computer system 12. Such interpretation will result in definition of one or more designated portions of the display present on the controlled computer system 12 monitor. Such portions may include graphical input devices, such as virtual buttons, windows, screen frames, display areas, specific images, specific text, and so forth. The corresponding portion of the screen as defined by the particular application generating the logical portion is then cached in memory as indicated at step 70 in FIG. 4. Again, the caching performed at step 70 will result in storage of a portion of the screen in cache memory 26 (See, FIG. 1).

At step 72, data indicative of the portion of the image cached at step 70 is transmitted from the controlled computer system 12 to the controlling computer system 14. In a simple example, the data transmitted at step 72 may simply include coordinates, limits, or similar boundaries of a portion of the screen to be logically grouped and cached. In a graphical user interface, for example, such boundaries may be defined by frames of an application window, limits or boundaries around a graphical input device or virtual button, and so forth. With the data defining the cached portion of the screen received by the controlling computer system 14, the identical portion of the screen is then cached by the controlling computer system 14 as indicated at step 74.

It should be noted that where certain types of screen portions are cached at step 74, data descriptive of other screen portions may be transmitted to facilitate completion of the desired operation. For example, where operations such as those illustrated in FIGS. 2 and 3 are to be performed, the controlling computer system 14 will not originally include data defining background used to fill areas that will be vacated by the iconified or displaced window. Thus, at step 72, this background data also may be transmitted to permit filling of the background upon execution of the operation.

At step 76, the requested operation is completed, including the iconification of FIG. 2, the move of FIG. 3, or any other desired change in the screen display resulting from the code of the applications running on the controlled computer system 12. At step 78, the actual command corresponding to the input event generated at the controlling computer system 14 is executed by the applications of the controlled computer system 12. Subsequent input events can then be made and processed by returning to step 64 in FIG. 4.

As will be appreciated by those skilled in the art, the foregoing procedure permits the controlling computer system 14 to display and cache screen portions as if the applications were being run by the controlling computer system 14, thereby allowing control of the applications run on the controlled computer system 12. The technique is particularly well-suited to collaborative computing environments in which the controlling computer is used to provide training or troubleshooting for the operator at the controlled computer. As described below, the technique may be employed with a plurality of controlling computers, so as to provide similar functionality at multiple locations. Moreover, the technique may be applied in applications where the controlled computer is coupled to a machine system, such as for actual control of the system. In such situations, the controlling computer may serve as an interface for remote monitoring, servicing, troubleshooting, user training, and various other administrative and interactive functions.

As will be appreciated by those skilled in the art, any suitable programming code and platform may be employed in the present technique. In a present implementation, a UNIX-based platform is employed in which events are posted as X-server commands. Other operating system platforms have similar event publication mechanisms. In the UNIX-based platform, event publication commands may generally be provided in an X-test module on the X-server. Also, in the present implementation, the controlled computer monitors for inputs on its own input devices. The technique makes use of a server application which is sent to the client (i.e., the controlled computer) and which is capable of knowing or recognizing the frame buffer protocol and server commands. In general, then, the controlling computer simply provides indications of input events to the controlled computer, with logical portions of the screen being successively cached to improve the speed of transmission and updating of the screens, and to reduce bandwidth load.

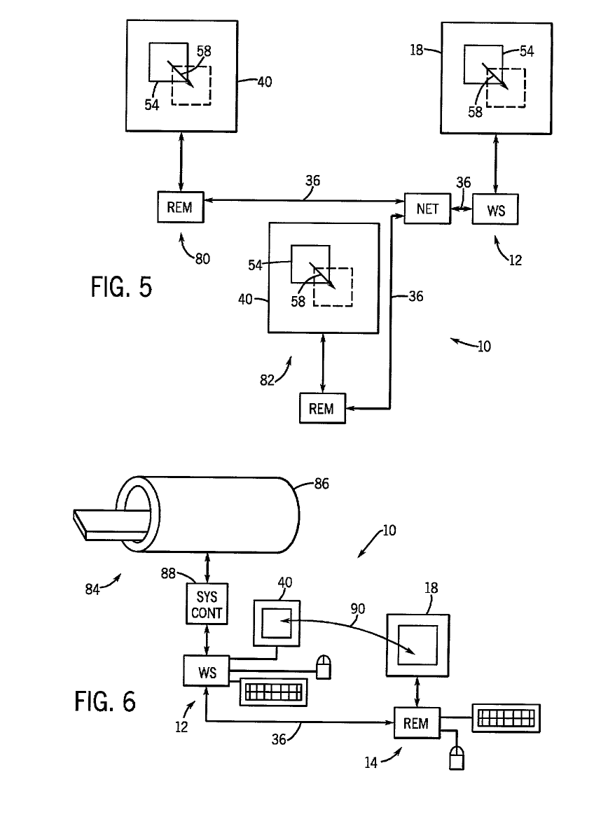

As noted above, the present technique may be employed with a plurality of computer systems. Such a scenario is illustrated diagrammatically in FIG. 5. As shown in FIG. 5, the system would include a first remote system 80 which serves as a controlling computer, and a second remote system 82 which serves as a second controlling computer. The remote systems are coupled to the controlled computer 12 via a network 36, such as the Internet. As discussed above with reference to FIGS. 1-4, screen data is captured and transmitted from screens provided on the controlled computer to both of the controlling computers 80 and 82 for display of the screen data, which is based on the program operating on the controlled computer 12. Inputs from either one of the controlling computers 80 and 82 are conveyed to the controlled computer 12, where they are received and interpreted in accordance with the type of input event and the program operating on the controlled computer 12. As in the previous example, a logical portion of the screen is then identified and instructions for caching the portion of the screen are transmitted from the controlled computer 12 back to the controlling computers 80 and 82. Thus, all of the computers 12, 80 and 82 in the system maintain similar screen views, with bandwidth load being reduced by virtue of the caching performed at both controlling computers.

As also noted above, the present technique may be employed for monitoring, servicing, troubleshooting, user training, and various other administrative and interactive functions, which may be associated with an actual person or physical system coupled to the controlled computer 12. By way of example, in a medical diagnostic situation, a medical diagnostic imaging system may be accessed and parameters relating to operation of the system may be viewed and modified by the controlling computer as desired. A scenario of this type is illustrated diagrammatically in FIG. 6. As shown in FIG. 6, the controlled computer system 12 is coupled to a medical diagnostic imaging system 84, such as a magnetic resonance imaging system. As will be appreciated by those skilled in the art, such imaging systems typically include a scanning arrangement 86 designed to acquire image data based upon a pre-established protocol and examination instructions provided by a system controller 88. The controlled computer system 12 serves as an interface for the imaging system and provides for operator input of operating parameters, settings, and so forth. Where training, troubleshooting, or where appropriate, actual control of the system from a remote location is desired, controlled computer system 12 may be linked to controlling system 14 via network 36. The controlling computer system may be located, by way of example, at a service provider location and staffed by field engineers or system experts. Thus, through implementation of the foregoing technique, the screen views produced on the controlled computer system 12 are conveyed through the controlling computer system and input events at the controlling computer system server to progressively cache portions of the screen to reduce bandwidth loads and to improve response of the system to the input events.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for remotely servicing a medical diagnostic imaging system, the method comprising:
providing a shared computing environment for a remote computing system coupled to a medical diagnostic imaging system; and
collaboratively interacting with the remote computing system via the shared computing environment to service the medical diagnostic imaging system.

2. The method of claim 1, wherein providing the shared computing environment comprises facilitating user collaboration between a plurality of remote computing systems via a network.

3. The method of claim 2, comprising communicating through the Internet.

4. The method of claim 1, wherein providing the shared computing environment comprises providing a shared interface to interact with the remote computing system.

5. The method of claim 4, wherein providing the shared interface comprises providing shared control of the remote computing system via the shared interface.

6. The method of claim 4, wherein providing the shared interface comprises simulating a graphical user interface of the remote computing system.

7. The method of claim 6, wherein simulating the graphical user interface comprises capturing screen data for a screen of the remote computing system.

8. The method of claim 1, wherein providing the shared computing environment comprises capturing, transmitting and caching screen data between the remote computing system and a desired computing system via the shared computing environment.

9. The method of claim 1, wherein providing the shared computing environment comprises facilitating communication between a plurality of operating systems.

10. The method of claim 1, wherein collaboratively interacting with the remote computing environment comprises remotely monitoring the medical diagnostic imaging system.

11. The method of claim 1, wherein collaboratively interacting with the remote computing environment comprises remotely executing a service procedure for the medical diagnostic imaging system.

12. The method of claim 1, wherein collaboratively interacting with the remote computing environment comprises remotely controlling a service program disposed on the remote computing system.

13. The method of claim 1, wherein collaboratively interacting with the remote computing environment comprises remotely interacting with a user of the medical diagnostic imaging system.

14. The method of claim 13, comprising remotely guiding the user through a service procedure by collaboratively interacting with a shared graphical user interface viewable by the user and by a remote service technician.

15. The method of claim 1, wherein collaboratively interacting with the remote computing environment comprises interacting with a UNIX operating system.

16. A method for remotely training persons having a medical diagnostic imaging system, the method comprising:
providing a collaborative computing environment between a trainee and a remote trainer for a medical diagnostic imaging system; and
interactively instructing the trainee via the collaborative computing environment.

17. The method of claim 16, wherein providing the collaborative computing environment comprises interacting with a UNIX operating system.

18. The method of claim 16, wherein providing the collaborative computing environment comprises providing a shared user interface.

19. The method of claim 18, wherein providing the shared user interface comprises capturing, transmitting and caching screen data between computing systems for the trainee and the trainer.

20. The method of claim 18, wherein providing the shared user interface comprises providing mutual operability of an application configured for training the trainee.

21. The method of claim 18, wherein providing the shared user interface comprises simulating a graphical user interface for the medical diagnostic imaging system.

22. The method of claim 21, wherein simulating the graphical user interface comprises:
capturing screen data for a display of the medical diagnostic imaging system; and
transmitting the screen data to a remote display of the remote trainer.

23. The method of claim 16, wherein interactively instructing the trainee comprises remotely interacting with an operating system for the medical diagnostic imaging system.

24. The method of claim 23, wherein remotely interacting with the operating system comprises platform-independently interacting with the operating system.

25. The method of claim 16, wherein interactively instructing the trainee comprises remotely initiating events in the medical diagnostic imaging system.

26. The method of claim 16, wherein interactively instructing the trainee comprises remotely responding to operations of the medical diagnostic imaging system.

27. The method of claim 16, wherein interactively instructing the trainee comprises remotely interacting with a plurality of geographically separate trainees via the collaborative computing environment.

28. A method for collaborating between remote computing environments, including a medical diagnostic imaging system, the method comprising:
initiating a link between remote computing environments;
sharing a graphical user interface with the remote computing environments; and
collaboratively interacting with a medical diagnostic imaging system coupled to one of the remote computing environments.

29. The method of claim 28, wherein initiating the link comprises communicating between a plurality of distinct operating systems for the remote computing environments.

30. The method of claim 28, wherein sharing the graphical user interface comprises providing independent and mutual control of an application associated with the graphical user interface.

31. The method of claim 28, wherein sharing the graphical user interface comprises:
capturing screen data for a first display of a first one of the remote computing environments; and
transmitting the screen data to a second display of a second one of the remote computing environments.

32. The method of claim 31, wherein sharing the graphical user interface comprises caching the screen data on a memory assembly.

33. The method of claim 28, wherein collaboratively interacting with the medical diagnostic imaging system comprises collaborating operations with a plurality of persons operating the remote computing environments.

34. A system for collaboratively interacting between remote computing environments associated with a medical diagnostic imaging system, the system comprising:
a first computing system coupled to a medical diagnostic imaging system;
a second computing system remotely coupled to the first computing system via a network; and
a user interface shared by the first and second computing systems for collaboratively interacting with the medical diagnostic imaging system.

35. The system of claim 34, wherein the user interface comprises a graphical interface operable on one of the first and second computing systems.

36. The system of claim 35, wherein the graphical interface is simulated on a different one of the first and second computing systems.

37. The system of claim 36, wherein the first computing system comprises an application providing the graphical interface and the second computing system comprises a simulation of the graphical interface.

38. The system of claim 37, wherein the simulation comprises screen data corresponding to the graphical interface.

39. The system of claim 37, wherein the user interface facilitates mutual control of the application by both the first and the second computing systems.

40. The system of claim 37, wherein the user interface facilitates real time shared operability of the medical diagnostic imaging system.

41. The system of claim 40, comprising a safety routine to prevent undesirable operation of the medical diagnostic imaging system.

42. The system of claim 40, comprising a cache memory assembly coupled to the network for caching screen data for the user interface.
